(19) United States
(12) Patent Application Publication
(10) Pub. No.: US 2026/0281815 A1
(43) Pub. Date: Sep. 17, 2026

(54) RADIO BASE STATION AND RADIO COMMUNICATION METHOD

(71) Applicant: NTT DOCOMO, INC., Tokyo (JP)

(72) Inventors: Mio NAKAMURA, Tokyo (JP); Tianyang MIN, Tokyo (JP)

(73) Assignee: NTT DOCOMO, INC., Tokyo (JP)

(21) Appl. No.: 19/471,424

(22) PCT Filed: Apr. 7, 2023
(86) PCT No.: PCT/JP2023/014401

§ 371 Date: Oct. 1, 2025

(51) Int. Cl. H04W 28/08; H04L 41/16; H04W 52/02

(52) U.S. Cl. CPC H04W 28/0917; H04L 41/16; H04W 52/0206

(57) ABSTRACT

A radio base station transmits or receives a message including energy cost information indicating energy consumed by radio communication with a terminal, and determines a saving action to save energy based on the energy cost information. The radio base station can determine a number of the terminals to be offloaded to another radio base station as the saving action.

### TECHNICAL FIELD

This disclosure relates to a radio base station and a radio communication method using an AI/ML Model.

### BACKGROUND ART

The 3rd Generation Partnership Project (3GPP, registered trademark) has specified the 5th generation mobile communication system (5G, also known as New Radio (NR) or Next Generation (NG)) and is also proceeding with the next generation specification called Beyond 5G, 5G Evolution or 6G.

In 3GPP Release 18, the function extension of Radio Access Network (NG-RAN) using a model (AI/ML Model) of artificial intelligence (AI)/machine learning (ML) is discussed (Non-Patent Literature 1).

Energy saving is attempted using an AI/ML model, for example, by exchanging information on energy cost (EC), such as power consumption of nodes through Xn interface, between nodes (radio base station, gNB), (Non-Patent Literature 2).

By exchanging EC between nodes, the nodes can determine an energy saving action (ES action) through which the power consumption can be most saved.

### CITATION LIST

### Patent Literature

Non-Patent Literature 1: “Revised WID: Artificial Intelligence (AI)/Machine Learning (ML) for NG-RAN,” RP-220635, 3GPP TSG RAN Meeting #95e, 3GPP, March 2022

[Non-Patent Literature 2] “RAN3 Chair Notes,” 3GPP TSG-RAN WG3 #119, February 2023

### SUMMARY OF INVENTION

However, the relationship between a specific ES action and an energy cost (EC) by the ES action is not always clear, and there is a problem that it is not easy to determine a reasonable ES action to be saved.

Therefore, the following disclosure has been made in view of such a situation, and aims to provide a radio base station and a radio communication method that can select a reasonable energy saving action (ES action) for an energy cost (EC) while utilizing an AI/ML model.

One aspect of the present disclosure is a radio base station (gNB 100) including: a transmission/reception unit (Xn processing unit 120) that transmits or receives a message including energy cost information indicating energy consumed by radio communication with a terminal; and a control unit (control unit 140) that determines a saving action to save the energy based on the energy cost information, in which the control unit determines a number of the terminals to be offloaded to another radio base stations as the saving action.

### BRIEF DESCRIPTION OF DRAWINGS

FIG. 1 is an overall schematic configuration diagram of a radio communication system 10.

FIG. 2 is a functional block diagram of a gNB 100.

FIG. 3 is a diagram illustrating an example of an AI/ML-related Xn message between a source node and a target node.

FIG. 4 is a diagram illustrating a configuration example of an ES action (Part 1).

FIG. 5 is a diagram illustrating a configuration example of an ES action (Part 2).

FIG. 6 is a diagram illustrating a sequence example of a predicted EC request and report.

FIG. 7 illustrates an IE configuration example of a predicted EC request (Part 1).

FIG. 8 illustrates an IE configuration example of a predicted EC report (Part 1).

FIG. 9 illustrates an IE configuration example of a predicted EC request (Part 2).

FIG. 10 illustrates an IE configuration example of a predicted EC report (Part 2).

FIG. 11 illustrates an IE configuration example of a predicted EC request (Part 3).

FIG. 12 illustrates an IE configuration example of a predicted EC report (Part 3).

FIG. 13 illustrates an IE configuration example of a predicted EC request (Part 4).

FIG. 14 illustrates an IE configuration example of a predicted EC report (Part 4).

FIG. 15 illustrates an example of a hardware configuration of the gNB and UE 200.

FIG. 16 illustrates a configuration example of vehicle 2001.

### DESCRIPTION OF EMBODIMENTS

Embodiments will be described below based on the drawings. The same functions and configurations are denoted by the same or similar reference signs, and their descriptions are omitted, as appropriate.

### (1) Overall Schematic Structure of Radio Communication System

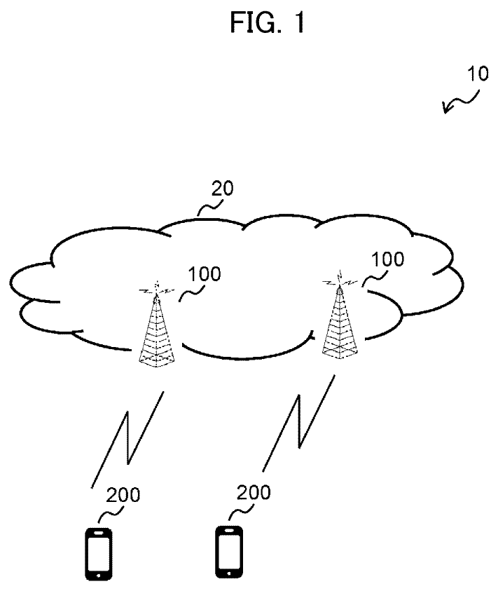

FIG. 1 is an overall schematic structure diagram of a radio communication system 10 according to this embodiment. The radio communication system 10 is a radio communication system according to 5G New Radio (NR), and includes Next Generation-Radio Access Network 20 (hereinafter referred to as NG-RAN 20) and terminals 200 (User Equipment 200 (hereinafter referred to as UE 200)).

The radio communication system 10 may be a radio communication system according to a system called Beyond 5G, 5G Evolution or 6G, or may include a radio communication system according to a system called Long Term Evolution (LTE) or 4G. The radio communication system 10 may support functions related to Industrial Internet of Things (IIoT) and URLLC (Ultra-Reliable and Low Latency Communications).

The NG-RAN 20 includes a radio base station 100 (which hereinafter may be referred to as gNB 100). Specific configurations of the radio communication system 10 including the number of gNBs (which may be eNBs,) and UEs are not limited to the example illustrated in FIG. 1.

The gNB 100 may also adopt a fronthaul (FH) interface specified by the Open Radio Access Network Alliance (O-RAN). The gNB 100 may include an O-DU (O-RAN Distributed Unit) and an O-RU (O-RAN Radio Unit). The gNB 100 may function as a kind of NG-RAN node.

The NG-RAN 20 actually includes a plurality of NG-RAN nodes, specifically gNBs (or ng-eNBs), and is connected to a core network (5 GC, not illustrated) according to 5G. The 5 GC may introduce the concept of Control and User Plane Separation (CUPS) in which the functions of the user plane and the control plane are clearly separated.

An Access and Mobility Management Function (AMF), which is included in the system architecture of 5G, and which provides the access and mobility management function of the UE 200, and a Session Management Function (SMF), which provides the session management function, are connected to the NG-RAN 20. Unified Data Management/User Data Repository (UDM/UDR) may be connected to the AMF and/or the SMF. The NG-RAN 20 and the 5 GC may be simply described as “networks.” The gNB 100 and the UE 200 control radio signals transmitted from a plurality of antenna elements to be able to support Massive MIMO, which generates a highly directional beam, Carrier Aggregation (CA), which bundles a plurality of component carriers (CCs), and Dual Connectivity (DC), which simultaneously communicates between the UE and each of the plurality of NG-RAN Nodes.

In this embodiment, Multi-Radio Dual Connectivity (MR-DC) in which any gNB 100 of the plurality of gNBs 100 constitutes a master node (MN) and another gNB 100 constitutes a secondary node (SN), specifically, NR-NR Dual Connectivity (NR-DC) in which the gNBs constitute an MN (MgNB) and an SN (SgNB) may be executed. Alternatively, E-UTRA-NR Dual Connectivity (EN-DC) or NR-E-UTRA Dual Connectivity (NE-DC), may be executed.

Thus, the UE 200 supports dual connectivity for connecting to the plurality of gNBs 100.

One of the gNBs 100 may be included in a master cell group (MCG) and other gNBs 100 may be included in a secondary cell group (SCG). The other gNBs 100 may be interpreted as an SN included in the SCG. The gNBs 100 may be referred to as a radio base station or a network device.

Further, in the radio communication system 10, artificial intelligence (AI)/machine learning (ML) may be applied for the NG-RAN 20. Specifically, an AI/ML model may be used to optimize the mobility or handover (which can be understood as transition, cell transition, cell selection, or the like) of the UE 200.

The AI/ML model may be expressed by another term which means AI or ML, such as an artificial intelligence (AI) model or a machine learning (ML) model.

Mobility of the UE 200 may mean easy movement and maneuverability of the UE 200 in a broad sense. However, in this embodiment, mobility of the UE 200 may mean minimization of call drop, radio link (including beam) failure, unnecessary handover, ping-pong state, and the like.

The radio communication system 10 can use such an AI/ML model to optimize the mobility or handover of the UE 200. The AI/ML model may be provided on the gNB 100 or the network side. The AI/ML model may also be provided on the UE 200.

In addition, in this embodiment, by exchanging information on energy cost (EC), for example, power consumption of RAN nodes (which may be simply called nodes) such as the gNB 100, it is possible to determine a saving action (ES action) to realize energy saving while using the AI/ML model.

The contents of the ES action are not particularly limited, but a typical action is to offload (load of) the UE 200 by handover the UE 200, to which the gNB 100 is connected, to another gNB (another radio base station), and thereby reducing the power consumption of the gNB 100.

### (2) Functional Block Configuration of Radio Communication System

Next, the functional block configuration of the radio communication system 10 will be described. Specifically, the functional block configuration of the gNB 100 will be described.

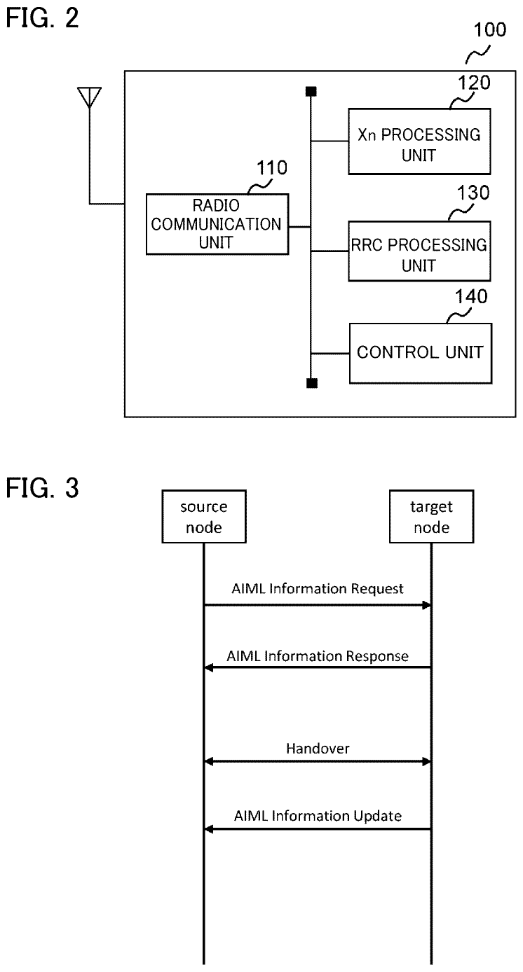

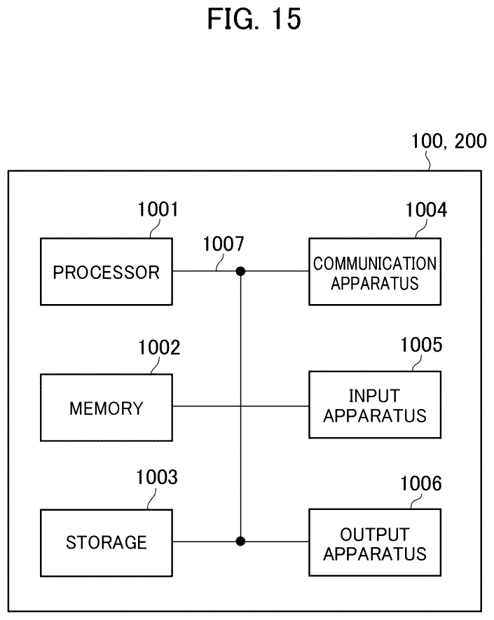

FIG. 2 is a functional block configuration diagram of the gNB 100. Note that only the main functional blocks related to the description of the embodiment are illustrated in FIG. 2, and the gNB 100 includes other functional blocks (for example, a power supply unit). FIG. 2 illustrates the functional block configuration of the gNB 100. For its hardware configuration, refer to FIG. 15.

As illustrated in FIG. 2, the gNB 100 includes a radio communication unit 110, an Xn processing unit 120, an RRC processing unit 130, and a control unit 140.

The radio communication unit 110 transmits a downlink signal (DL signal) in accordance with NR. The radio communication unit 110 receives an uplink signal (UL signal) in accordance with NR.

The Xn processing unit 120 processes messages via the Xn interface, which is one type of interface between RAN (Radio Access Network) nodes. Specifically, the Xn processing unit 120 can transmit and receive messages in accordance with an XnAP (Application Protocol). More specifically, the Xn processing unit 120 may transmit and receive various messages in accordance with XnAP specified in 3GPP TS 38.423 .

When the gNB 100 adopts a CU-DU configuration, the Xn processing unit 120 may transmit and receive various messages in accordance with F1AP specified in 3GPP TS38.473 between CUs and DUs.

In this embodiment, the Xn processing unit 120 can transmit or receive an Xn message containing energy cost (EC) information indicating energy consumed by radio communication with a terminal. In this embodiment, the Xn processing unit 120 may constitute a transmission/reception unit.

For example, the total amount of electric power consumed by radio communication (which may include communications related to initial connections, cell transitions (such as handover)) with a terminal connected to the gNB 100 (one or more terminals may be connected to the gNB 100) via a cell formed by the gNB 100 may be EC, and the Xn processing unit 120 may transmit or receive an Xn message containing energy cost information regarding the EC. Note that target UE may include not only a connected (RRC_CONNECTED) UE but also the UE in a different state such as RRC_INACTIVE.

In addition, the Xn processing unit 120 may transmit a message including a saving action (ES action) for saving energy (such as electric power) consumed by the gNB 100 to another gNB. Said another gNB may typically be a gNB that forms a cell adjacent to a cell formed by the gNB 100, that is, a gNB that forms a cell that becomes a candidate (target) of a terminal transition destination.

The ES action may be defined by the following information:
Number of the UEs to be offloaded
Types of the UEs to be offloaded
Throughput or data volume of the UEs to be offloaded
Scenario for offloading
   Details of each piece of information will be described below.

The Xn processing unit 120 may transmit an Xn message containing a plurality of ES actions to another gNB, and may receive from said another gNB an Xn message containing a predicted increase (predicted EC) in energy to be borne by said another radio gNB by executing the plurality of ES actions. In addition, the Xn processing unit 120 may receive from said another gNB an Xn message containing information indicating the actual energy increase in said another gNB when the ES action above is applied. A value of the EC (including predicted EC) may be expressed as an absolute value, or may be expressed as an increase or decrease from a specific reference value.

The RRC processing unit 130 executes various processes in a radio resource control layer (RRC). For example, the RRC processing unit 130 can transmit RRC Reconfiguration to the UE 200. The RRC processing unit 130 can also receive RRC Reconfiguration Complete, which is a response to the RRC Reconfiguration, from the UE 200.

The RRC processing unit 130 may also execute various processes related to RRC messages transmitted and received between RAN nodes (gNBs).

The control unit 140 controls each functional block constituting the gNB 100. In particular, in this embodiment, the control unit 140 controls energy consumed by the gNB 100.

Specifically, the control unit 140 can determine an ES action to save energy consumed in the gNB 100 based on the energy cost information related to the EC described above. The AI/ML model may be used to predict the energy cost (EC) consumed in the gNB 100, and the energy saved by the ES action, as described above. However, the use of the AI/ML model is not necessarily assumed. The energy may typically be power consumption, but a different reference (for example, a generated heat amount) may be used.

For example, the control unit 140 may determine the number of terminals to be offloaded from its own cell to another gNB as the ES action. The number of terminals may be expressed as an absolute value, or may be expressed as an increase or decrease relative to a specific reference value.

Alternatively, the control unit 140 may determine at least one of the following as the ES action: type of the terminals to be offloaded, throughput of the terminals to be offloaded, data amount transmitted and received by the terminals to be offloaded, or an offloading method of the terminals. Specific examples of each ES action will be described below.

Further, the control unit 140 may determine the ES action for each terminal to be offloaded. Specifically, the control unit 140 may specify a terminal to be offloaded using identification information (such as Radio Network Temporary Identifier: RNTI) that can identify the terminal.

### (3) Operation of Radio Communication System

Next, operation of the radio communication system 10 will be described. Specifically, the operation related to the ES action in the gNB 100 using the AI/ML Model will be described.

### (3.1) Assumptions and Issues

As described above, in the radio communication system 10, energy cost (EC) can be exchanged between nodes via the Xn interface to realize energy saving(ES).

Here, the EC may be understood as a metric representing the power consumption (decrease at source (offload source), increase at target (offload destination)) of a node that changes when the UE is offloaded for a candidate UE to be offloaded. However, as described above, the EC may not necessarily be based on the electric power. In addition, it may include a case where a part of the radio resource (such as CC, Resource Block (RB)) used for connection with the UE is offloaded without offloading the UE itself.

By exchanging the EC via the Xn interface, the node can determine the ES action (content of the offload) that consumes the least electric power.

An operation example below describes an example of the ES action associated with the EC when requesting an estimated value of the power consumption change (EC) of the node for a specific ES action. Also, an example of information that the node requesting the EC (source node) should transmit to the target node (target node) is described.

### (3.2) Operation Example

### (3.2.1) Operation Example 1

One ES action may be defined by the following information (parameters):
Number of the UEs to be offloaded
Types of the UEs to be offloaded
Throughput or data volume (performance) of the UEs to be offloaded
Scenario for offloading
   The number of the UEs may be the number of physical or logical UEs. The types of the UEs may be classified by, for example, a terminal such as a normal smartphone (normal UE) or a terminal for IoT (Internet of Things) (IoT UE).

Throughput may mean an amount of data communication per unit time (bit/sec). Data volume may mean a total amount of data communication (bits) transmitted and received (relayed) by the node since the start of communication with the UE. The amount of data communication or the total amount of data communication may be distinguished between a UL and a DL, or the total amount of communication between the UL and the DL.

Offloading may mean reducing resources allocated by a particular node to execute communication with a particular UE by allowing another node to take over the communication with the UE. In this case, offloading may be realized by establishing a DC by handover of the UE or by adding primary and secondary cells (PSCell), or by changing the PSCell.

A source node may adopt an ES action that reduces the power consumption of its own node the most. The source node may send one or more ES action candidates to a neighboring node (target node) using a message. The neighboring node may reply to the source node with the predicted increase in power consumption (predicted EC) expected for each ES action.

One ES action may be included in one Xn message, or information of multiple ES actions may be included as a list in one message. If only one piece of the information above is provided by the list, only the piece of information need be included in the list.

After the source node takes an ES action by comparing the predicted EC received from the target node with the estimated power consumption (predicted EC) associated with the UE that the target node is responsible for, the target node may notify the source node of the actual change in power consumption (actual EC).

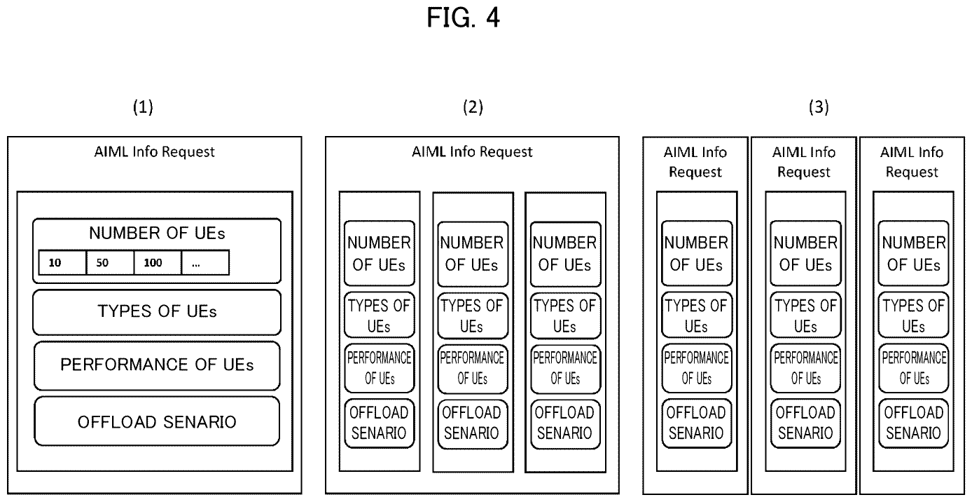

FIG. 3 illustrates an example of an AI/ML-related Xn message between the source node and the target node. FIG. 4 illustrates a configuration example (part 1) of an ES action.

As illustrated in FIGS. 3 and 4, information representing ES actions can be included in, for example, an AIML Information Request, and may be enumerated by a list of some parameters as illustrated in (1) of FIG. 4. Alternatively, the information may be enumerated as a list of ES actions as illustrated in (2) of FIG. 4, and an individual message (AIML Information Request) may be transmitted for each ES action as illustrated in (3) of FIG. 4.

It should be noted that a predicted EC request/response, and an actual EC report may be performed by any of the following messages:
(a) Existing Xn message (such as resource status report)
(b) AIML class 1 (for example, AI/ML Information Request/Response) or class 2 (for example, AI/ML Information Update) message (see Non-Patent Literature 2)
(c) New class 1 or class 2 message dedicated to energy saving

FIG. 3 illustrates an example sequence using the message (b).

### (3.2.2) Operation Example 2

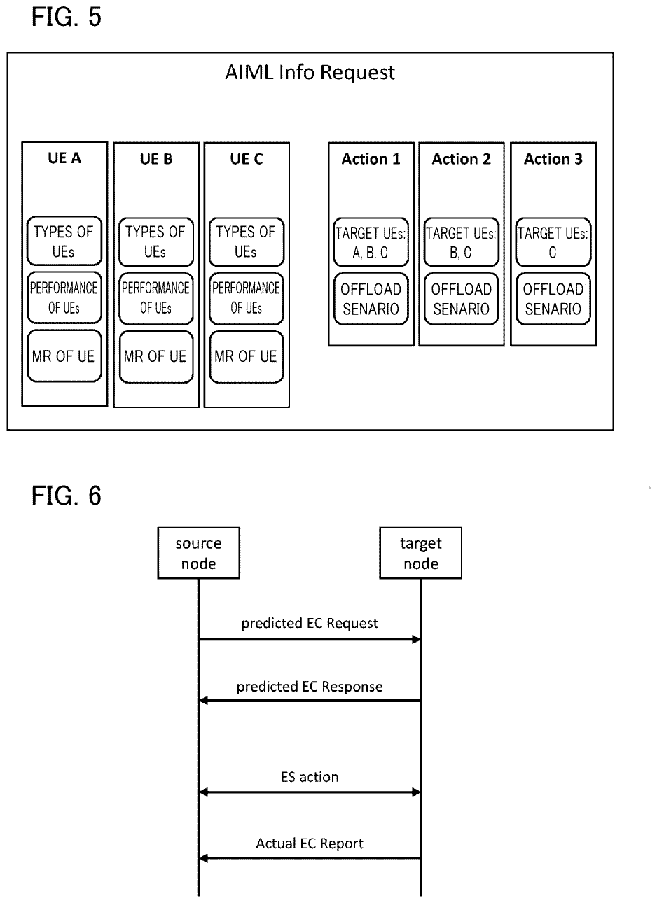

FIG. 5 illustrates a configuration example of an ES action (Part 2). As described above, information representing an ES action can be included in the AIML Information Request, but the information may include parameters that can specify a specific UE, as illustrated in FIG. 5.

Specifically, an ES action may be defined by the combination of the UEs to be offloaded, distinguishing the UEs. In the example illustrated in FIG. 5, type, performance (throughput, data volume), and measurement report (MR) content of the UE are illustrated for each of three UEs (UE A, B, C). In addition, three actions (Action 1, 2, 3) are defined, and each action includes the UE to be offloaded and a scenario to be offloaded. By targeting a specific UE in this way, a more detailed ES action can be realized.

### (3.3) Operation Example

FIG. 6 illustrates an example sequence related to a predicted EC request and report. As illustrated in FIG. 6, the predicted EC request and report may be performed according to a class 2 procedure.

The actual EC report may be performed according to a class 1 procedure or a response message of the class 2 procedure.

The actual EC report may be implicitly transmitted from the target node to the source node when the predicted EC request is received, or may be triggered by an explicit request from the source node.

As described above, the request, response, and report illustrated in FIG. 6 may be implemented by the types of messages (a), (b), or (c) described above.

### (3.4) Configuration Example of Information Element (IE)

Next, a configuration example of an information element (IE) related to a predicted EC request and report will be described.

### (3.4.1) Configuration Example 1

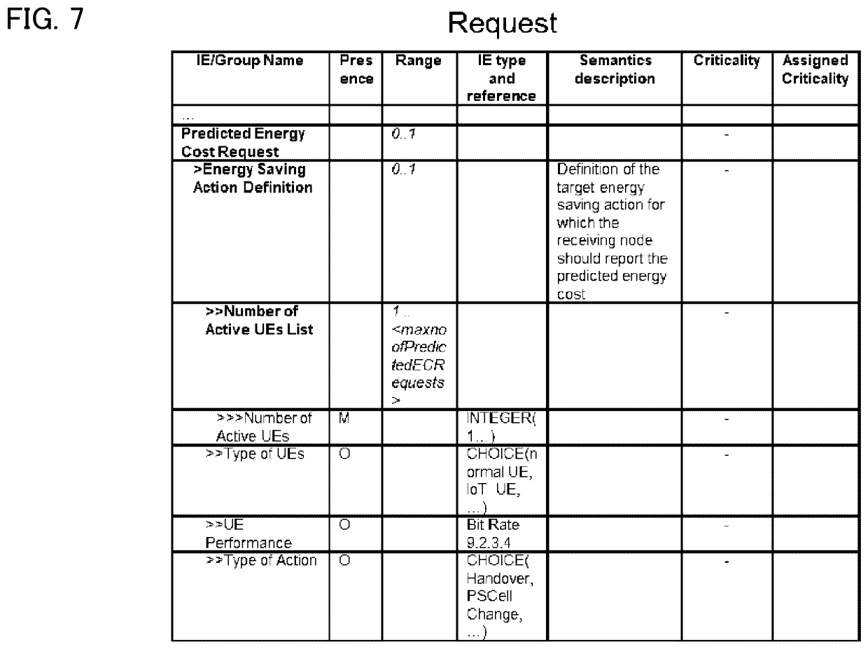

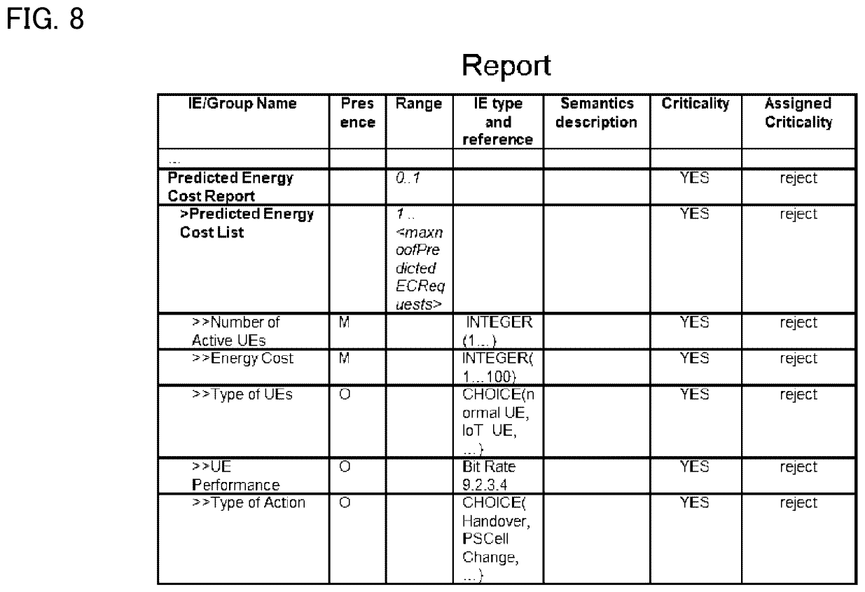

FIG. 7 illustrates an IE configuration example (part 1) of a predicted EC request. FIG. 8 illustrates an IE configuration example (part 1) of a predicted EC report. As described above, an IE requesting a predicted EC report may be added to the Xn message, and information on the ES action may be included in the IE.

In the examples of FIGS. 7 and 8, multiple number of UEs may be included in the IE as a list, and the target node may report predicted EC for each number of the UEs.

<maxnoofPredictedECRequests> is a new constant that specifies how many ES actions may be included in one request. In this example, an index of the number of the UEs to be offloaded is the mean number of active UEs, which is an existing IE, but it may be another IE related to the number of the UEs, the number of the UEs to be offloaded, or the amount of load. Note that parts other than the configuration of the IE do not necessarily have to configured as illustrated in FIGS. 7 and 8.

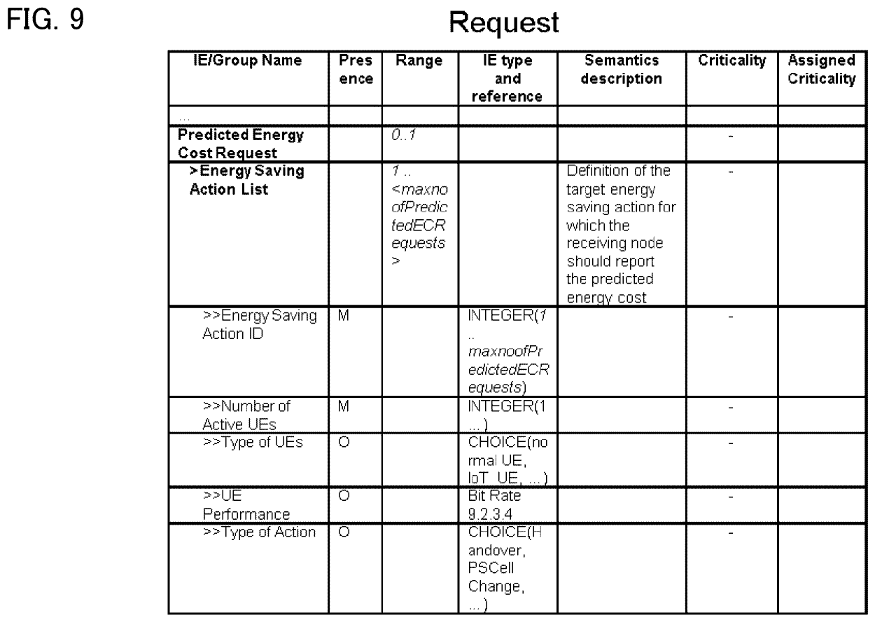

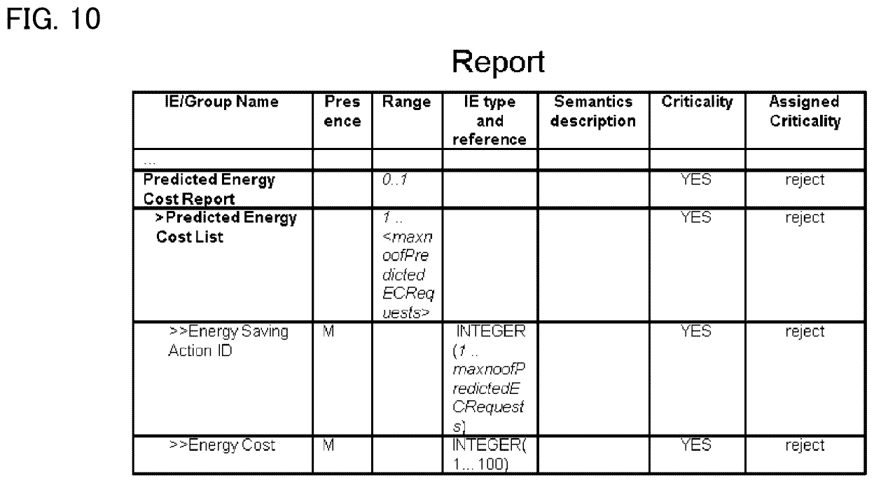

FIG. 9 illustrates an IE configuration example (part 2) of a predicted EC request. FIG. 10 illustrates an IE configuration example (part 2) of a predicted EC report. In the example of FIGS. 9 and 10, requests for predicted EC reports for multiple ES actions may be included as a list in one message, and the target node may transmit a list of the predicted EC for each ES action.

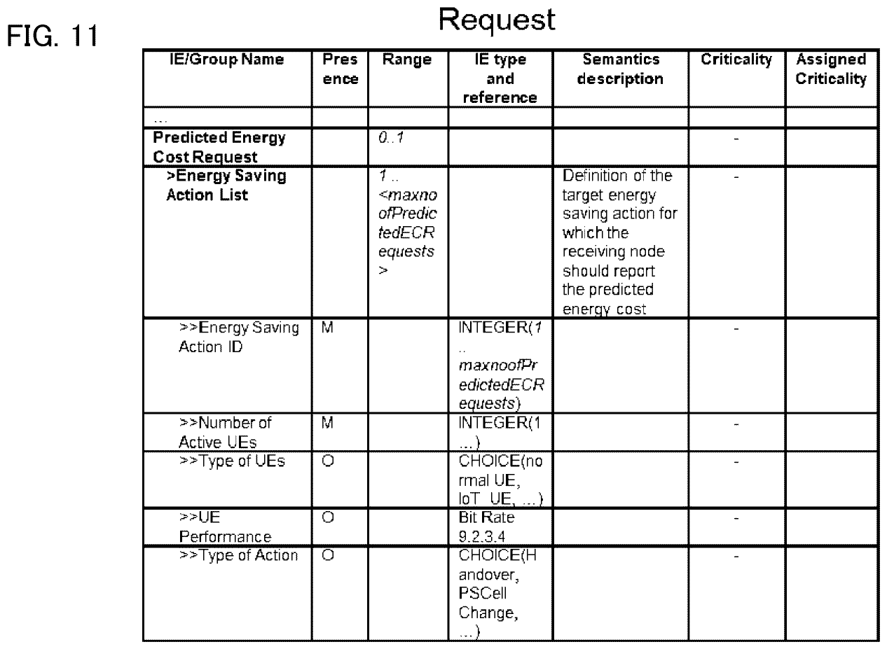

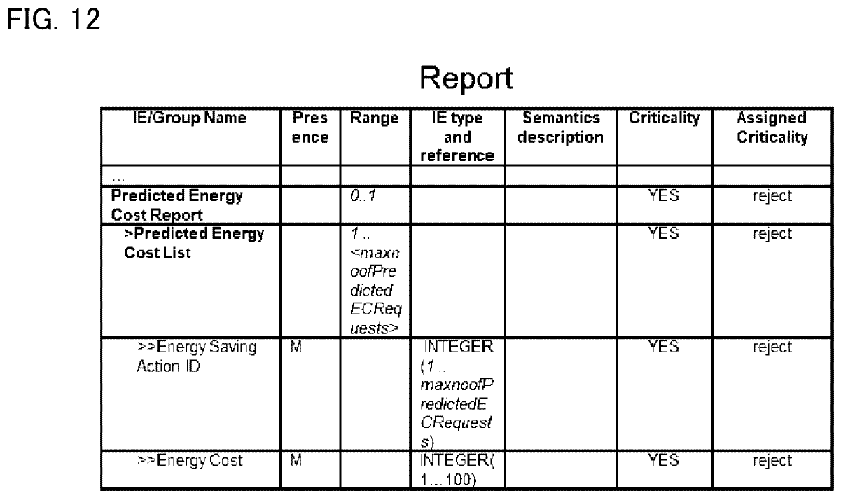

FIG. 11 illustrates an IE configuration example of (part 3) of a predicted EC request. FIG. 12 illustrates an IE configuration example (part 3) of a predicted EC report. In the examples illustrated in FIGS. 11 and 12, only one request for a predicted EC report on an ES action may be included in one message.

When a request is transmitted in multiple messages, the request may be distinguished by a different ID included in the messages, or the request may be distinguished by an Energy Saving Action ID assigned as a Mandatory IE.

### (3.4.2) Configuration Example 2

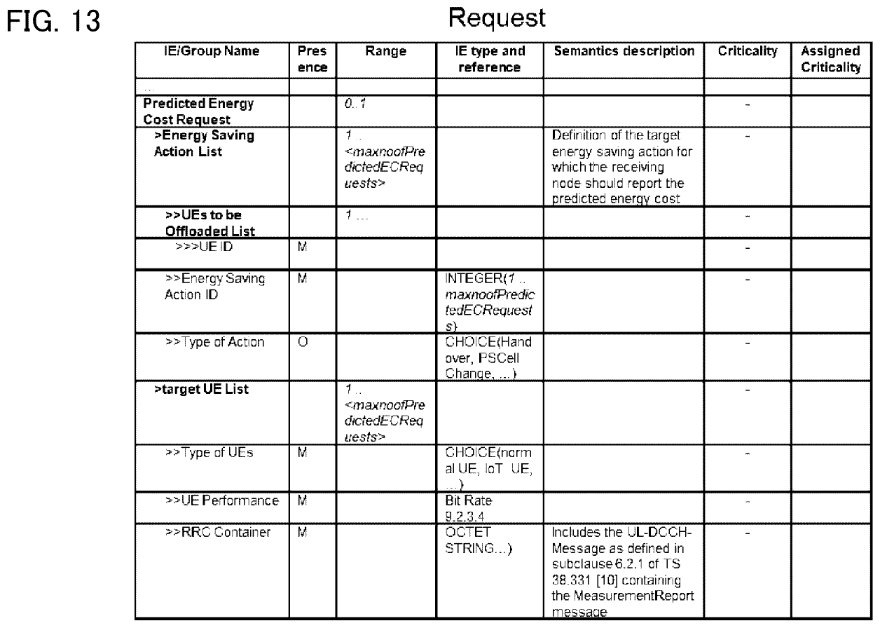

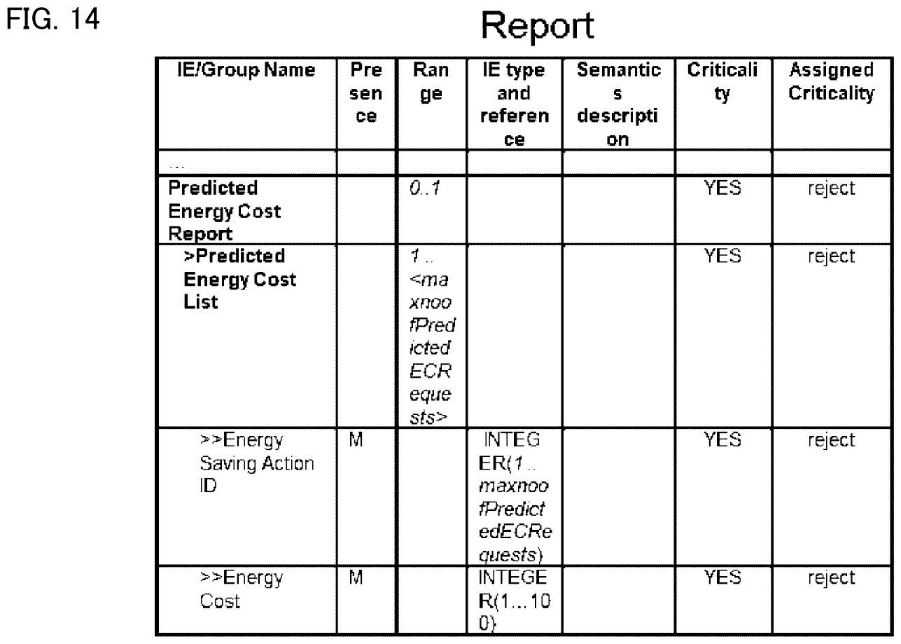

FIG. 13 illustrates an IE configuration example (Part 4) of a predicted EC request. FIG. 14 illustrates an IE configuration example (Part 4) of a predicted EC report.

As illustrated in FIGS. 13 and 14, an IE requesting a predicted EC report may be added to the Xn message. The IE may contain information on the ES action.

In addition, the ES action may be expressed by a combination of different UEs associated with the communication status or the like by a Measurement Report (MR). The UE ID may be an ID (such as RNTI) that can identify the UE to be offloaded.

### (4) Operation and Effect

According to the embodiments above, the following operation and effect are obtained. Specifically, the gNB 100 can select a suitable ES action that can reduce the power consumption of an entire network by requesting or reporting the predicted EC associated with the ES action on the Xn interface. That is, the gNB 100 can select a suitable ES action for the energy cost (EC) to be saved while using an AI/ML model.

In addition, by feeding an actual EC back to the AI/ML Model side, prediction accuracy by the AI/ML Model can be improved.

In this embodiment, the gNB 100 can determine at least one of the following as the ES action: type of the terminals to be offloaded, throughput of the terminals to be offloaded, data amount transmitted and received by the terminals to be offloaded, or offloading method of the terminals. Therefore, a precise ES action can be selected according to the state of energy consumption that can change from moment to moment.

In this embodiment, the gNB 100 (source node) can obtain predicted EC. Therefore, a more suitable ES action can be selected considering the state of a offload destination node.

In this embodiment, the ES action can also be determined for each terminal to be offloaded. Therefore, a pinpoint ES action for a specific UE can be selected.

### (5) Other Embodiments

Although the embodiments have been described above, it is obvious to those skilled in the art that various modifications and improvements can be made without being limited to the description of the embodiments.

For example, in the embodiments described above, the gNB 100 determines the ES action, but other RAN nodes (which may be called communication nodes, communication devices, or the like) may perform similar operations.

In the above disclosure, terms such as configure, activate, update, indicate, enable, specify, and select may be read interchangeably. Similarly, terms such as link, associate, correspond, and map may be read interchangeably, and terms such as allocate, assign, monitor, and map may be read interchangeably.

In addition, terms such as specific, dedicated, UE-specific, and UE-dedicated may be read interchangeably. Similarly, terms such as common, shared, group-common, UE-common, and UE-shared may be read interchangeably.

The block diagram (FIG. 2) used in the description of the above-described embodiment illustrates blocks in units of functions. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining software into the apparatus described above or the plurality of apparatuses described above.

Functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit), ” a “transmitter,” and the like. The method for implementing each component is not particularly limited as described above.

Further, the above-described gNB 100 and UE 200 (the devices) may function as a computer that performs processing of a radio communication method of the present disclosure. FIG. 15 is a diagram illustrating an example of a hardware configuration of the device. As illustrated in FIG. 15, the device may be configured as a computer device including a processor 1001, a memory 1002, a storage 1003, a communication device 1004, an input device 1005, an output device 1006, a bus 1007, and the like.

Furthermore, in the following description, the term “device” can be read as meaning circuit, device, unit, or the like. The hardware configuration of the device may include one or more devices illustrated in the figure or may not include some of the devices.

Each of the functional blocks of the device (FIG. 2) is implemented by means of any of hardware elements of the computer device or a combination of the hardware elements.

Each function in the device is realized by loading predetermined software (programs) on hardware such as the processor 1001 and the memory 1002 so that the processor 1001 performs arithmetic operations to control communication via the communication device 1004 and to control at least one of reading and writing of data on the memory 1002 and the storage 1003.

The processor 1001 controls the whole computer by, for example, running an operating system. The processor 1001 may be configured with a0 central processing unit (CPU), which includes interfaces with peripheral apparatus, control apparatus, computing apparatus, a register, and so on.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. The various processes have been described to be performed by a single processor 1001. However, the processes may be performed by two or more processors 1001 simultaneously or sequentially. The processor 1001 may be implemented by one or more chips. It should be noted that the program may be transmitted from a network via a telecommunication line.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “auxiliary storage apparatus.” The above recording medium may be a database including the memory 1002 and/or the storage 1003, a server, or any other appropriate medium.

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on.

The communication apparatus 1004 may be configured to include a high frequency switch, a duplexer, a filter, a frequency synthesizer, and so on in order to realize, for example, at least one of frequency division duplex (FDD) and time division duplex (TDD).

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the device may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

Notification of information is by no means limited to the aspects/embodiments described in the present disclosure, and other methods may be used as well. For example, notification of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information block (SIB), and so on), Medium Access Control (MAC) signaling), and other signals or combinations of these. Also, RRC signaling may be referred to as an “RRC message,” and can be, for example, an RRC connection setup message, an RRC connection reconfiguration message, and so on.

The aspects/embodiments illustrated in the present disclosure may be applied to Long Term Evolution (LTE), LTE-Advanced (LTE-A), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New Radio (NR), W-CDMA (registered trademark), GSM (registered trademark), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods, next-generation systems that are enhanced, modified, created, or defined based on these, and the like. A plurality of systems may be combined (for example, a combination of LTE or LTE-A and 5G, and the like) for application.

The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

Operations which have been described in the present disclosure to be performed by a base station may, in some cases, be performed by an upper node of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these. According to the above, a case is described in which there is a single network node other than the base station 10. However, a combination of multiple other network nodes may be considered (e.g., MME and S-GW).

Information or signals (information and the like) may be output from a higher layer (or lower layer) to a lower layer (or higher layer). The information or signals may be input or output through multiple network nodes.

The input or output information may be stored in a specific location (e.g., memory) or managed using management tables. The input or output information may be overwritten, updated, or added. The information that has been output may be deleted. The information that has been input may be transmitted to another apparatus.

A decision or a determination in an embodiment of the present invention may be realized by a value (0 or 1) represented by one bit, by a boolean value (true or false), or by comparison of numerical values (e.g., comparison with a predetermined value).

Each aspect/embodiment described in the present specification may be used independently, may be used in combination, or may be used by switching according to operations. Further, notification (transmission/reporting) of predetermined information (e.g., notification (transmission/reporting) of “X”) is not limited to an explicit notification (transmission/reporting), and may be performed by an implicit notification (transmission/reporting) (e.g., by not performing notification (transmission/reporting) of the predetermined information).

Software should be broadly interpreted to mean, whether referred to as software, firmware, middle-ware, microcode, hardware description language, or any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL), etc.) or wireless technologies (infrared, microwave, etc.), at least one of these wired line technologies or wireless technologies is included within the definition of the transmission medium.

Information, a signal, or the like, described in the present specification may be represented by using any of a one of various different technologies. For example, data, an instruction, a command, information, a signal, a bit, a symbol, a chip, or the like, described throughout the present application, may be represented by a voltage, an electric current, electromagnetic waves, magnetic fields, magnetic particle, optical fields, a photon, or a combination thereof.

It should be noted that a term used in the present specification and/or term required for understanding of the present specification may be replaced by a term having the same or similar meaning. For example, a channel and a symbol may be a signal (signaling). Further a signal may also be a message. Further, the component carrier (CC) may be referred to as a carrier frequency, cell, frequency carrier, or the like.

As used in the present disclosure, the terms “system” and “network” are used interchangeably.

Furthermore, the information, parameters, and the like, described in the present disclosure may be expressed using absolute values, relative values from a predetermined values, or they may be expressed using corresponding different information. For example, a radio resource may be what is indicated by an index.

The names used for the parameters described above are not used as limitation. Further, the mathematical equations using these parameters may differ from those explicitly disclosed in the present disclosure. Because the various channels (e.g., PUCCH, PDCCH) and information elements may be identified by any suitable names, the various names assigned to these various channels and information elements are not used as limitations.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a “small cell,” a “femto cell,” a “pico cell,” and so on.

A base station can accommodate one or a plurality of (for example, three) cells (also called sectors). When a base station accommodates a plurality of cells, the entire coverage area of the base station can be partitioned into multiple smaller areas, and each smaller area can provide communication services through base station subsystems (for example, indoor small base stations (Remote Radio Heads (RRHs))).

The term “cell” or “sector” refers to part of or the entire coverage area of at least one of a base station and a base station subsystem that provides communication services within this coverage.

In the present disclosure, transmitting information to the terminal by the base station may be referred to as instructing the terminal to perform any control and/or operation based on the information by the base station.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on. The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

Furthermore, the base station in the present disclosure may be interpreted as a mobile station (hereinafter, a user terminal). For example, each aspect/embodiment of the present disclosure may be applied to the structure that replaces a communication between a base station and a mobile station with a communication between a plurality of mobile stations (for example, which may be referred to as “Device-to-Device (D2D),” “Vehicle-to-Everything (V2X),” and the like). In this case, mobile stations may have the functions of the base stations described above. The words such as “uplink” and “downlink” may be interpreted as the words corresponding to the terminal-to-terminal communication (for example, “side”). For example, an uplink channel, a downlink channel and so on may be interpreted as a sidelink channel (or sidelink).

Likewise, the mobile station in the present disclosure may be interpreted as base station. In this case, the base station may have the functions of the mobile station described above.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” In other words, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot,” a “mini-slot,” or the like, instead of a “subframe.”

Here, a TTI refers to the minimum time unit of scheduling in radio communication, for example. For example, in LTE systems, a base station performs, for user terminals, scheduling of allocating radio resources (such as a frequency bandwidth and transmit power available for each user terminal) in TTI units. Note that the definition of the TTI is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot,” or the like. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, or the like) may be interpreted as a TTI having a time length exceeding 1 ms, and a short TTI (for example, a shortened TTI or the like) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

An RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),”a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a UE may not need to assume to transmit/receive a certain signal/channel outside the active BWP(s). Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

The term “connected” or “coupled” or any variation thereof means any direct or indirect connection or connection between two or more elements and may include the presence of one or more intermediate elements between the two elements “connected” or “coupled” with each other. The coupling or connection between the elements may be physical, logical, or a combination thereof. For example, “connection” may be read as “access”. As used in the present disclosure, the two elements may be thought of as being “connected” or “coupled” to each other using at least one of the one or more wires, cables, or printed electrical connections and, as a number of non-limiting and non-inclusive examples, electromagnetic energy having wavelengths in the radio frequency region, the microwave region, and the light (both visible and invisible) region.

A reference signal may be abbreviated as an “RS,” and may be referred to as a “pilot,” and so on, depending on which standard applies.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

“Means” included in the configuration of each of the above apparatuses may be replaced by “parts”, “circuits”, “devices”, etc.

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

In the case where the terms “include”, “including” and variations thereof are used in the present disclosure, these terms are intended to be comprehensive in the same way as the term “comprising”. Further, the term “or” used in the present specification is not intended to be an “exclusive or”.

In the present disclosure, where an article is added by translation, for example “a”, “an”, and “the”, the disclosure may include that the noun following these articles is plural.

As used herein, the term “determining” may encompasses a wide variety of actions. For example, “determining” may be regarded as judging, calculating, computing, processing, deriving, investigating, looking up (e.g., looking up in a table, a database or another data structure), ascertaining and the like. Also, “determining” may be regarded as receiving (e.g., receiving information), transmitting (e.g., transmitting information), inputting, outputting, accessing (e.g., accessing data in a memory) and the like. Also, “determining” may be regarded as resolving, selecting, choosing, establishing and the like. That is, “determining” may be regarded as a certain type of action related to determining.

In this disclosure, the term “A and B are different” may mean “A and B are different from each other.” It should be noted that the term “A and B are different” may mean “A and B are different from C.” Terms such as “separated” or “combined” may be interpreted in the same way as the above-described “different”.

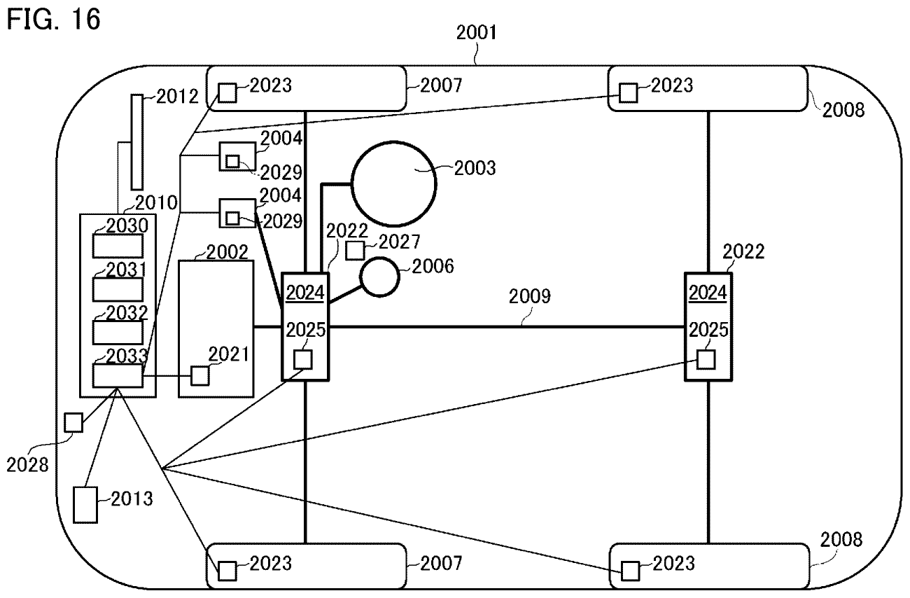

FIG. 16 shows a configuration example of a vehicle 2001. As shown in FIG. 16, the vehicle 2001 includes a drive unit 2002, a steering unit 2003, an accelerator pedal 2004, a brake pedal 2005, a shift lever 2006, left and right front wheels 2007, left and right rear wheels 2008, an axle 2009, an electronic control unit 2010, various sensors 2021 to 2029, an information service unit 2012, and a communication module 2013.

The drive unit 2002 may include, for example, an engine, a motor, and a hybrid of an engine and a motor. The steering unit 2003 includes at least a steering wheel and is configured to steer at least one of the front wheel or the rear wheel, based on the operation of the steering wheel operated by the user. The electronic control unit 2010 includes a microprocessor 2031, a memory (ROM, RAM) 2032, and a communication port (IO port) 2033. The electronic control unit 2010 receives signals from the various sensors 2021-2027 provided in the vehicle. The electronic control unit 2010 may be referred to as an ECU (Electronic control unit).

The signals from the various sensors 2021 to 2028 include a current signal from a current sensor 2021 which senses the current of the motor, a front or rear wheel rotation signal acquired by a revolution sensor 2022, a front or rear wheel pneumatic signal acquired by a pneumatic sensor 2023, a vehicle speed signal acquired by a vehicle speed sensor 2024, an acceleration signal acquired by an acceleration sensor 2025, a stepped-on accelerator pedal signal acquired by an accelerator pedal sensor 2029, a stepped-on brake pedal signal acquired by a brake pedal sensor 2026, an operation signal of a shift lever acquired by a shift lever sensor 2027, and a detection signal, acquired by an object detection sensor 2028, for detecting an obstacle, a vehicle, a pedestrian, and the like.

The information service unit 2012 includes various devices for providing various kinds of information such as driving information, traffic information, and entertainment information, including a car navigation system, an audio system, a speaker, a television, and a radio, and one or more ECUs controlling these devices. The information service unit 2012 provides various types of multimedia information and multimedia services to the occupants of the vehicle 1 by using information obtained from the external device through the communication module 2013 or the like.

The information service unit 2012 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving support system unit 2030 includes: various devices for providing functions of preventing accidents and reducing driver's operating loads such as a millimeter wave radar, a LiDAR (Light Detection and Ranging), a camera, a positioning locator (e.g., GNSS, etc.), map information (e.g., high definition (HD) map, autonomous vehicle (AV) map, etc.), a gyro system (e.g., IMU (Inertial Measurement Unit), INS (Inertial Navigation System), etc.), an AI (Artificial Intelligence) chip, an AI processor; and one or more ECUs controlling these devices. In addition, the driving support system unit 2030 transmits and receives various types of information via the communication module 2013 to realize a driving support function or an autonomous driving function.

The communication module 2013 may communicate with the microprocessor 2031 and components of the vehicle 1 via a communication port. For example, the communication module 2013 transmits and receives data via a communication port 2033, to and from the drive unit 2002, the steering unit 2003, the accelerator pedal 2004, the brake pedal 2005, the shift lever 2006, the left and right front wheels 2007, the left and right rear wheels 2008, the axle 2009, the microprocessor 2031 and the memory (ROM, RAM) 2032 in the electronic control unit 2010, and sensors 2021 to 2028 provided in the vehicle 2001.

The communication module 2013 is a communication device that can be controlled by the microprocessor 2031 of the electronic control unit 2010 and that is capable of communicating with external devices. For example, various kinds of information are transmitted to and received from external devices through radio communication. The communication module 2013 may be internal to or external to the electronic control unit 2010. The external devices may include, for example, a base station, a mobile station, or the like.

The communication module 2013 may transmit at least one of signals from the various sensors 2021 to 2028 described above input to the electronic control unit 2010, information obtained based on the signals, and information based on an input from the outside (a user) obtained via the information service unit 2012, to the external apparatus via radio communication. The electronic control unit 2010, the various sensors 2021 to 2028, the information service unit 2012, and the like may be referred to as input units that receive input. For example, the PUSCH transmitted by the communication module 2013 may include information based on the input.

The communication module 2013 receives various types of information (traffic information, signal information, inter-vehicle information, etc.) transmitted from the external devices and displays the received information on the information service unit 2012 provided in the vehicle. In addition, the communication module 2013 stores the various types of information received from the external devices in the memory 2032 available to the microprocessor 2031. Based on the information stored in the memory 2032, the microprocessor 2031 may control the drive unit 2002, the steering unit 2003, the accelerator pedal 2004, the brake pedal 2005, the shift lever 2006, the left and right front wheels 2007, the left and right rear wheels 2008, the axle 2009, the sensors 2021-2028, etc., mounted in the vehicle 2001.

Although the present disclosure has been described in detail above, it will be obvious to those skilled in the art that the present disclosure is not limited to the embodiments described in the present disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### (Supplementary Notes)

The disclosure above may be expressed as follows.

A first feature is a radio base station including: a transmission/reception unit that transmits or receives a message including energy cost information indicating energy consumed by radio communication with a terminal; and a control unit that determines a saving action to save the energy based on the energy cost information, wherein the control unit determines the number of the terminals to be offloaded to another radio base station as the saving action.

A second feature according to the first feature, in which the control unit determines at least one of the following as the saving action: type of the terminals to be offloaded, throughput of the terminals to be offloaded, data amount transmitted and received by the terminals to be offloaded, or an offloading method of the terminals.

A third feature according to the first or second feature, in which the transmission/reception unit transmits a message including a plurality of the saving actions to said another radio base station, and receives from said radio base station a message including a predicted increase in energy to be borne by said another radio base station by executing the plurality of the saving actions.

A fourth feature according to the first to third features, in which the transmission/reception unit receives from said another radio base station a message including information indicating actual energy increase in said another radio base station when the saving action is applied.

The fifth feature according to the first to fourth features, in which the control unit determines the saving action for each of the terminals to be offloaded.

### REFERENCE SIGNS LIST

10 Radio communication system
20 NG-RAN
100 gNB
110 Radio communication unit
120 Xn processing unit
130 RRC processing unit
140 Control unit
200 UE
1001 Processor
1002 Memory
1003 Storage
1004 Communication device
1005 Input device
1006 Output device
1007 Bus
2001 Vehicle
2002 Drive unit
2003 Steering unit
2004 Accelerator pedal
2005 Brake pedal
2006 Shift lever
2007 Left and right front wheels
2008 Left and right rear wheels
2009 Axle
2010 Electronic control unit
2012 Information service unit
2013 Communication module
2021 Current sensor
2022 Revolution sensor
2023 Pneumatic sensor
2024 Vehicle speed sensor
2025 Acceleration sensor
2026 Brake pedal sensor
2027 Shift lever sensor
2028 Object detection sensor
2029 Accelerator pedal sensor
2030 Driving support system unit
2031 Microprocessor
2032 Memory (ROM, RAM)
2033 Communication port

1. A radio base station comprising:
a transmission/reception unit that transmits or receives a message including energy cost information indicating energy consumed by radio communication with a terminal; and
a control unit that determines a saving action to save the energy based on the energy cost information, wherein
the control unit determines a number of the terminals to be offloaded to another radio base station as the saving action.

2. The radio base station according to claim 1, wherein the control unit determines at least one of the following as the saving action: type of the terminals to be offloaded, throughput of the terminals to be offloaded, a data amount transmitted and received by the terminals to be offloaded, or an offloading method of the terminals.

3. The radio base station according to claim 1, wherein the transmission/reception unit transmits a message including a plurality of the saving actions to the another radio base station, and receives from the radio base station a message including a predicted increase in energy to be borne by the another radio base station by executing the plurality of the saving actions.

4. The radio base station according to claim 3, wherein the transmission/reception unit receives from the another radio base station a message including information indicating actual energy increase in the another radio base station when the saving action is applied.

5. The radio base station according to claim 1, wherein the control unit determines the saving action for each of the terminals to be offloaded.

6. A radio communication method comprising:
a step of transmitting or receiving a message including energy cost information indicating energy consumed by radio communication with a terminal; and
a step of determining a saving action to save the energy based on the energy cost information, wherein
in the step of determining, a number of the terminals to be offloaded to another radio base station is determined as the saving action.
